(19) United States
(12) Patent Application Publication
(10) Pub. No.: US 2011/0090902 A1
(43) Pub. Date: Apr. 21, 2011

(54) System and method for providing quality of service considering priorities of terminals in a communication system

(75) Inventor: Joon-Ho Jung, Seongnam-si (KR)

(73) Assignee: Samsung Electronics Co., Ltd., Suwon-si (KR)

(21) Appl. No.: 12/925,303

(22) Filed: Oct. 19, 2010

(30) Foreign Application Priority Data
Oct. 19, 2009 (KR) 10-2009-0099241

(51) Int. Cl. H04L 12/66; G06F 15/16

(52) U.S. Cl. 370/352; 709/204

(57) ABSTRACT

Quality of Service (QoS) is provided based on a priority of a terminal in a communication system. A communication server receives Session Description Protocol (SDP) information and priority information of each of first and second terminals, and transmits, to a Policy Decision Function block (PDF), the SDP information of each of first and second terminals and priority information corresponding to a highest priority in the priority information of the first and second terminals. The PDF performs authentication based on QoS profile information of the first and second terminals acquired from a service profile server upon request for SDP information of each of the terminals, generates a QoS decision value based on the authentication results, and reserves resources that the first terminal will use to perform a communication service with the second terminal, using the QoS decision value. The PDF upgrades the QoS decision value based on the highest-priority information.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Oct. 19, 2009 and assigned Serial No. 10-2009-0099241, the entire disclosure of which is hereby incorporated by reference.

### TECHNICAL FIELD OF THE INVENTION

The present invention relates to a system and method for providing Quality of Service (QoS) considering the priorities of terminals in a communication system.

### BACKGROUND OF THE INVENTION

In next-generation communication systems, an increasing number of users are expected to require a variety of high-speed QoS, and to this end, many researches are underway to provide a Voice over Internet Protocol (VoIP) service to the users.

To provide the VoIP service, a process of establishing a session between the users using a Session Initiation Protocol (SIP) is required, and the session establishment process includes a Session Description Protocol (SDP) negotiation process. The SDP negotiation process refers to a process of negotiating over QoS parameters, e.g., information about the codec and bandwidth now in use, between a transmitting terminal and a receiving terminal by inserting SDP information into an SIP message. Information about a media type-specific bandwidth, to which each codec is applied, is also negotiated in the same method as the codec and bandwidth information negotiation method, and the bandwidth information is leveled down such that it may be satisfied in both the transmitting terminal and the receiving terminal.

The codec and bandwidth information negotiated through the SDP negotiation process is delivered to a Policy Decision Function block (PDF), and the PDF generates a QoS decision value using the codec and bandwidth information, and delivers the QoS decision value to an Internet Protocol (IP) edge. The QoS decision value includes a QoS class and a Maximum Bit Rate (MBR)/Guaranteed Bit Rate (GBR).

The IP edge performs resource reservation for an access network and QoS marking for an IP packet. In particular, the IP edge manages the traffic QoS classes it should apply during resource reservation, and QoS marking information based on their characteristics, for example, Differentiated Service Code Point (DSCP) codes, according to the characteristics of QoS classes.

However, the conventional QoS decision value generation method is limited to providing only the same QoS for the same service regardless of the priorities of terminals receiving a service. That is, when performing resource reservation and QoS marking using the QoS decision value received from the PDF, the IP edge selects the same traffic QoS class and performs the same QoS marking, or the same DSCP code marking, for each terminal regardless of the priorities of the terminals.

In the conventional session establishment process, since negotiation on the codec and bandwidth information is performed considering capability of each terminal, it is not simply that for a terminal having the high priority, a high-quality codec can be selected or a bandwidth can be increased. Therefore, the PDF generates the QoS decision value using the codec and bandwidth information that was negotiated considering only the capability of each terminal regardless of the priorities of terminals. In addition, the PDF refers to terminal-specific QoS profile information in generating the QoS decision value. Currently, however, since the terminal-specific QoS profile information is set the same for every terminal in a peer-to-peer (P2P) service, the priorities of terminals may not be normally reflected in the QoS decision value.

### SUMMARY OF THE INVENTION

To address the above-discussed deficiencies of the prior art, it is a primary object to provide at least the advantages described below. Accordingly, an aspect of embodiments of the present invention is to provide a system and method for providing a service considering the priority of a terminal in a communication system.

Another aspect of embodiments of the present invention is to provide a system and method for generating a QoS decision value capable of providing QoS of a terminal having a highest priority, reserving resources based on the QoS decision value, and performing QoS marking in a communication system.

Another aspect of embodiments of the present invention is to provide a system and method for allowing each terminal to be provided proper QoS corresponding to its priority in a communication system providing a P2P service.

In accordance with one aspect of the present invention, there is provided a system for providing Quality of Service (QoS) considering a priority of a terminal in a communication system. The system includes a first terminal and a second terminal. The system also includes a communication server for receiving Session Description Protocol (SDP) information and priority information of each of the first and second terminals, and transmitting, to a Policy Decision Function block (PDF), the SDP information of each of the first and second terminals and priority information corresponding to a highest priority in the priority information of the first and second terminals. The system also includes a QoS profile server for providing QoS profile information of the first and second terminals. The system also includes the PDF for performing authentication for the first and second terminals based on the QoS profile information of the first and second terminals acquired from the QoS profile server upon request for SDP information of each of the first and second terminals, generating a QoS decision value using the authentication results, and reserving resources that the first terminal will use to perform a communication service with the second terminal, using the QoS decision value. The PDF upgrades the QoS decision value based on the highest-priority information.

In accordance with another aspect of the present invention, there is provided a system for providing Quality of Service (QoS) considering a priority of a terminal in a communication system. The system includes a first terminal and a second terminal. The system also includes a communication server for receiving Session Description Protocol (SDP) information and priority information of each of the first and second terminals, identifying priority information corresponding to a highest priority in the priority information of the first and second terminals, deciding a QoS marking value of a terminal having the identified priority information among the first and second terminals using a QoS marking table based on terminal's priority information, and transmitting the decided QoS marking value to the first terminal. The first terminal decides final SDP information that the first terminal will use for communication based on the SDP information of the first and second terminals, generates a QoS decision value using the decided final SDP information and the QoS marking value, and reserves resources that the first terminal will use to perform a communication service with the second terminal using the QoS decision value.

In accordance with another aspect of the present invention, there is provided a system for providing Quality of Service (QoS) considering a priority of a terminal in a communication system. The system includes a first terminal and a second terminal. The system also includes a communication server for providing a communication service of the second terminal to the first terminal. The first terminal receives Session Description Protocol (SDP) information and priority information of the second terminal, identifies priority information corresponding to a highest priority in the priority information of the first and second terminals, decides a QoS marking value of a terminal having the identified priority information among the first and second terminals using a QoS marking table based on terminal's priority information, decides final SDP information that the first terminal will use for communication based on the SDP information of the first and second terminals, generates a QoS decision value using the decided final SDP information and the QoS marking value, and reserves resources that the first terminal will use to perform a communication service with the second terminal, using the QoS decision value.

In accordance with another aspect of the present invention, there is provided a method for providing Quality of Service (QoS) considering a priority of a terminal in a communication system, in which a communication server receives Session Description Protocol (SDP) information and priority information of each of first and second terminals, and transmits, to a Policy Decision Function block (PDF), the SDP information of each of the first and second terminals and priority information corresponding to a highest priority in the priority information of the first and second terminals. In the method, the PDF performs authentication for the first and second terminals based on QoS profile information of the first and second terminals acquired from a service profile server upon request for SDP information of each of the first and second terminals, generates a QoS decision value based on the authentication results, and reserves resources that the first terminal will use to perform a communication service with the second terminal, using the QoS decision value. Also in the method, the PDF upgrades the QoS decision value based on the highest-priority information.

In accordance with another aspect of the present invention, there is provided a method for providing Quality of Service (QoS) considering a priority of a terminal in a communication system, in which a communication server receives Session Description Protocol (SDP) information and priority information of each of first and second terminals, identifies priority information corresponding to a highest priority in the priority information of the first and second terminals, decides a QoS marking value of a terminal having the identified priority information among the first and second terminals using a QoS marking table based on terminal's priority information, and transmits the decided QoS marking value to the first terminal. In the method, the first terminal decides final SDP information that the first terminal will use for communication based on the SDP information of the first and second terminals, generates a QoS decision value using the decided final SDP information and the QoS marking value, and reserves resources that the first terminal will use to perform a communication service with the second terminal using the QoS decision value.

In accordance with another aspect of the present invention, there is provided a method for providing Quality of Service (QoS) considering a priority of a terminal in a communication system, in which a first terminal receives Session Description Protocol (SDP) information and priority information of a second terminal, identifies priority information corresponding to a highest priority in the priority information of the first and second terminals, and decides a QoS marking value of a terminal having the identified priority information among the first and second terminals using a QoS marking table based on terminal's priority information. In the method, the first terminal decides final SDP information that the first terminal will use for communication based on the SDP information of the first and second terminals, generates a QoS decision value using the decided final SDP information and the QoS marking value, and reserves resources that the first terminal will use to perform a communication service with the second terminal, using the QoS decision value.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates architecture of a VoIP network (with a PDF) providing a VoIP service according to an embodiment of the present invention;

FIG. 2 illustrates architecture of a VoIP network (without a PDF) providing a VoIP service according to another embodiment of the present invention;

FIG. 3 illustrates a procedure for registering a user in a VoIP network according to an embodiment of the present invention;

FIGS. 4A and 4B illustrate a procedure for establishing a session in a VoIP network according to the embodiment of the present invention depicted in FIG. 3;

FIG. 5 illustrates a procedure for registering a user in a VoIP network according to another embodiment of the present invention;

FIGS. 6A and 6B illustrate a procedure for establishing a session in a VoIP network according to the embodiment of the present invention depicted in FIG. 5;

FIG. 7 illustrates a procedure for registering a user in a VoIP network according to another embodiment of the present invention; and

FIG. 8 illustrates a procedure for establishing a session in a VoIP network according to the embodiment of the present invention depicted in FIG. 7.

Throughout the drawings, the same drawing reference numerals will be understood to refer to the same elements, features and structures.

### DETAILED DESCRIPTION OF THE INVENTION

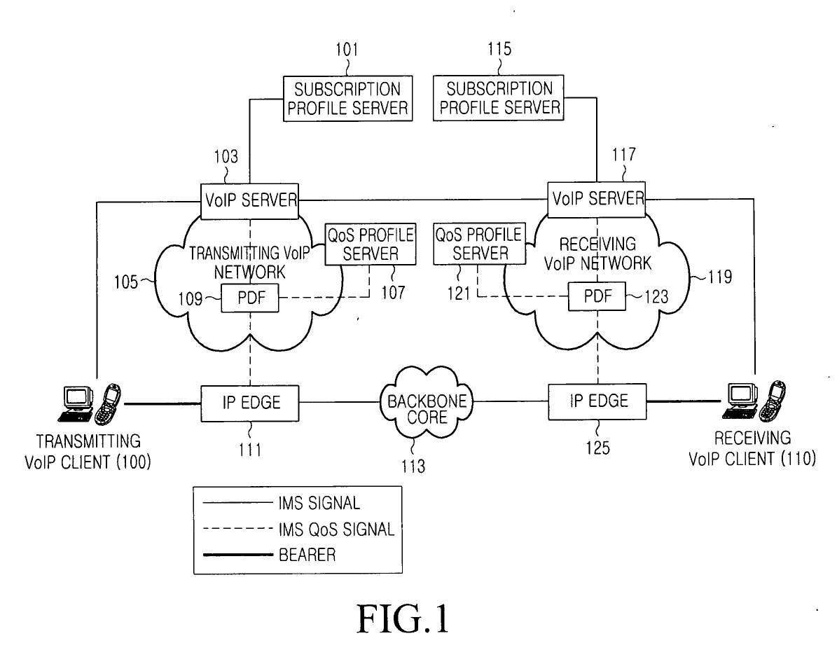

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged communication system. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

In this specification, detailed descriptions will be made of an embodiment of generating a QoS decision value capable of providing QoS of a terminal having the highest priority, reserving resources based on the QoS decision value, and performing QoS marking in a communication system.

In addition, detailed descriptions will be made of an embodiment of allowing each terminal to be provided proper QoS based on its priority in a communication system providing a peer-to-peer (P2P) service.

It should be noted that in this specification, the term ‘user’ as used herein refers to a ‘terminal’, and the terms ‘user’ and ‘terminal’ are used in the same meaning.

FIG. 1 shows architecture of a VoIP network (with a Policy Decision Function block (PDF)) providing a VoIP service according to an embodiment of the present invention.

Referring to FIG. 1, the VoIP network includes a transmitting VoIP client 100, a transmitting VoIP network 105, a receiving VoIP client 110, a receiving VoIP network 119, subscription profile servers 101 and 115, VoIP servers 103 and 117, QoS profile servers 107 and 121, PDFs 109 and 123, IP edges 111 and 125, and a backbone core 113.

The VoIP servers 103 and 117 operate as session controllers, and serve as SIP registrars. If authentications of their associated VoIP clients 100 and 110 have been completed, the VoIP servers 103 and 117 download service profiles including user priority information from the subscription profile servers 101 and 115 using Internet Protocol (IP) Multimedia Subsystem (IMS) signals, respectively. The subscription profile servers 101 and 115 store and manage not only user priority information indicating user priorities, but also user-specific authentication information and service information.

The user priority information means priority information assigned to each user. For example, users handling important information in the security department, or users frequently making emergency calls may be assigned high priority information.

Upon receiving REGISTER messages from the transmitting and receiving VoIP clients 100 and 110, respectively, the VoIP servers 103 and 117 transmit 200 OK response messages including the user priority information to the VoIP clients 100 and 110. Thereafter, the VoIP servers 103 and 117 perform a Session Description Protocol (SDP) negotiation process with the transmitting and receiving VoIP clients 100 and 110. The VoIP servers 103 and 117 deliver the SDP negotiation results and user priority information to the PDFs 109 and 123 using IMS QoS signals. The SDP negotiation results include information about the codec and bandwidth now in use between the transmitting and receiving VoIP clients 100 and 110.

The PDFs 109 and 123 perform authentication based on the SDP negotiation results received from the VoIP servers 103 and 117, and associated users' QoS profiles downloaded from the QoS profile servers 107 and 121 using IMS QoS signals. The PDFs 109 and 123 generate final QoS decision values, and transmit the generated final QoS values to the IP edges 111 and 125 using IMS QoS signals. The QoS profile servers 107 and 121 store and manage user-specific priority information, an authorized service list, service-specific Maximum Bit Rate (MBR)/Guaranteed Bit Rate (GBR) information, and so forth. The final QoS decision value includes a QoS class, an MBR/GBR and a QoS marking value.

After generating the final QoS decision values, the PDFs 109 and 123 determine whether to upgrade the final QoS decision values based on the QoS class of the user having the highest priority among the users having participated in the call, received from the VoIP servers 103 and 117.

To be specific, the PDFs 109 and 123 first compare a reference QoS class of the user being referenced by the PDFs 109 and 123, with a QoS class of the user having the highest priority among the users having participated in the call. The PDFs 109 and 123 update the final QoS decision values if the QoS class of the user having the highest priority is higher than the reference QoS class of the user.

The IP edges 111 and 125 reserve resources for the QoS class and MBR/GBR using the final QoS decision values received from the PDFs 109 and 123, and perform QoS marking, for example, Differentiated Service Code Point (DSCP) code marking, for IP packets transmitted to the backbone core 113, thereby providing user's QoS.

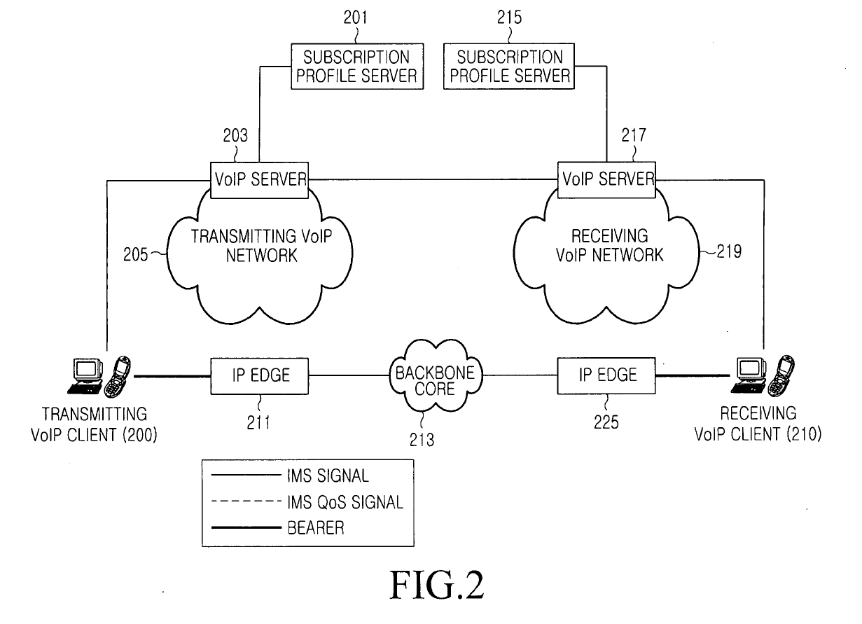

FIG. 2 shows architecture of a VoIP network (without a PDF) providing a VoIP service according to another embodiment of the present invention.

Referring to FIG. 2, the VoIP network includes a transmitting VoIP client 200, a transmitting VoIP network 205, a receiving VoIP client 210, a receiving VoIP network 219, subscription profile servers 201 and 215, VoIP servers 203 and 217, IP edges 211 and 225, and a backbone coder 213.

The VoIP servers 203 and 217 operate as session controllers, and serve as SIP registrars. The VoIP servers 203 and 217 receive user priority information the moment the transmitting and receiving VoIP clients 200 and 210 are registered. In addition, before performing the service, the VoIP servers 203 and 217 download QoS marking tables based on user priority information from an Operation Supporting System (OSS).

If authentications of users have been completed, the VoIP servers 203 and 217 may deliver both the users' priority information and the QoS marking tables to their associated VoIP clients 200 and 210. Alternatively, the VoIP servers 203 and 217 may deliver only the users' priority information to their associated VoIP clients 200 and 210, and hold their QoS marking tables.

If the VoIP servers 203 and 217 deliver both the users' priority information and QoS marking tables to their associated VoIP clients 200 and 210, the VoIP clients 200 and 210 generate QoS decision values based on the SDP negotiation results and the QoS marking tables in a session establishment process. The QoS decision value includes a QoS Class Identifier (QCI), an MBR/GBR and a QoS marking value. Based on the generated QoS decision values, the transmitting and receiving VoIP clients 200 and 210 generate bearer connections and perform QoS marking, for example, DSCP code marking, on IP packets.

If the VoIP servers 203 and 217 deliver only the users' priority information to their associated VoIP clients 200 and 210, and hold their QoS marking tables, then the VoIP servers 203 and 217 decide QoS marking values based on the user priority information received from the transmitting and receiving VoIP clients 200 and 210, and transmit the decided QoS marking values to the transmitting and receiving VoIP clients 200 and 210 along with the SDP negotiation results.

Then the transmitting and receiving VoIP clients 200 and 210 generate QoS decision values based on the received SDP negotiation results. Based on the generated QoS decision values, the transmitting and receiving VoIP clients 200 and 210 generate bearer connections and perform QoS marking on IP packets.

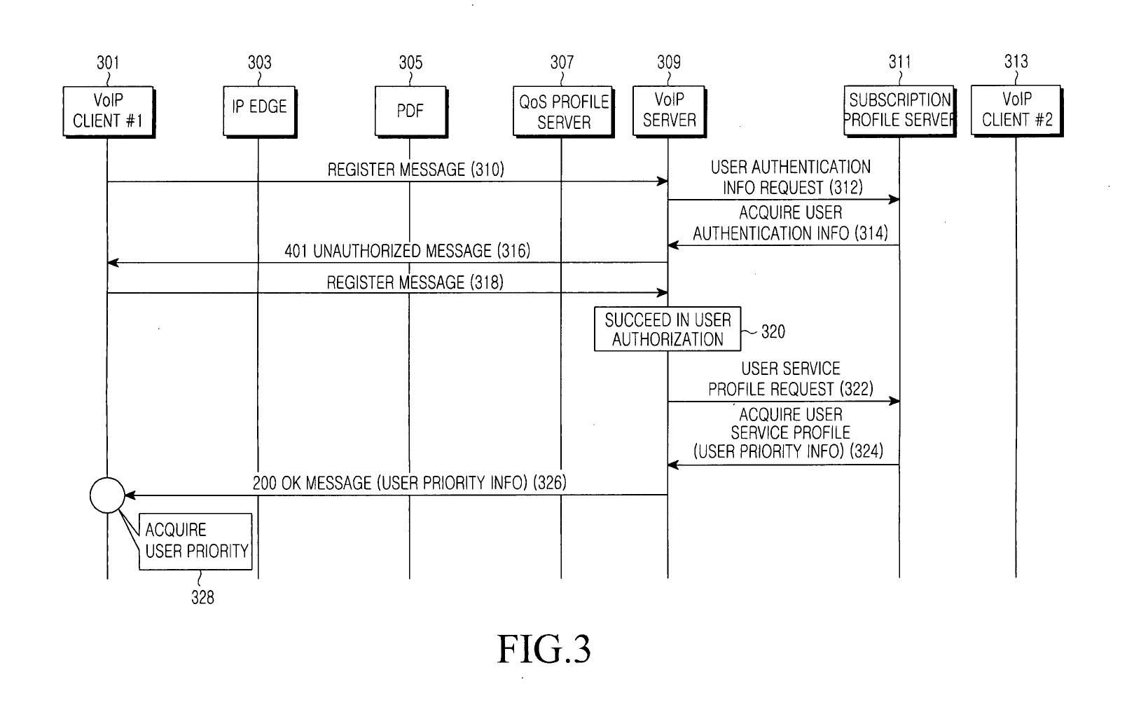

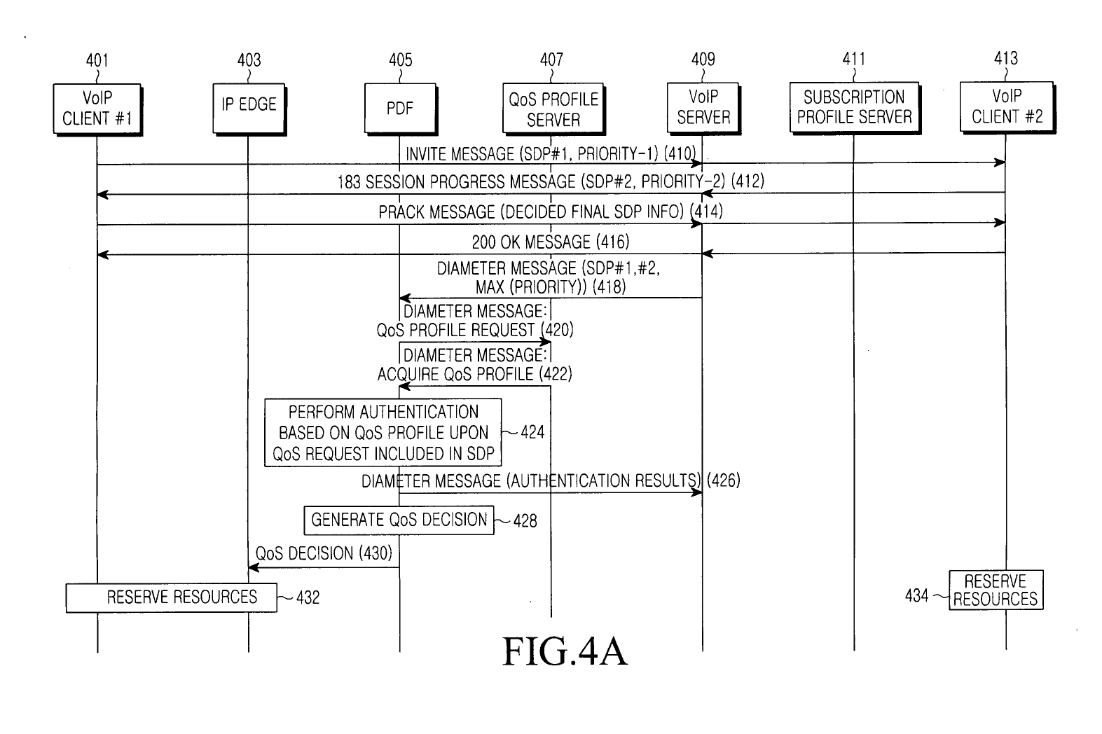

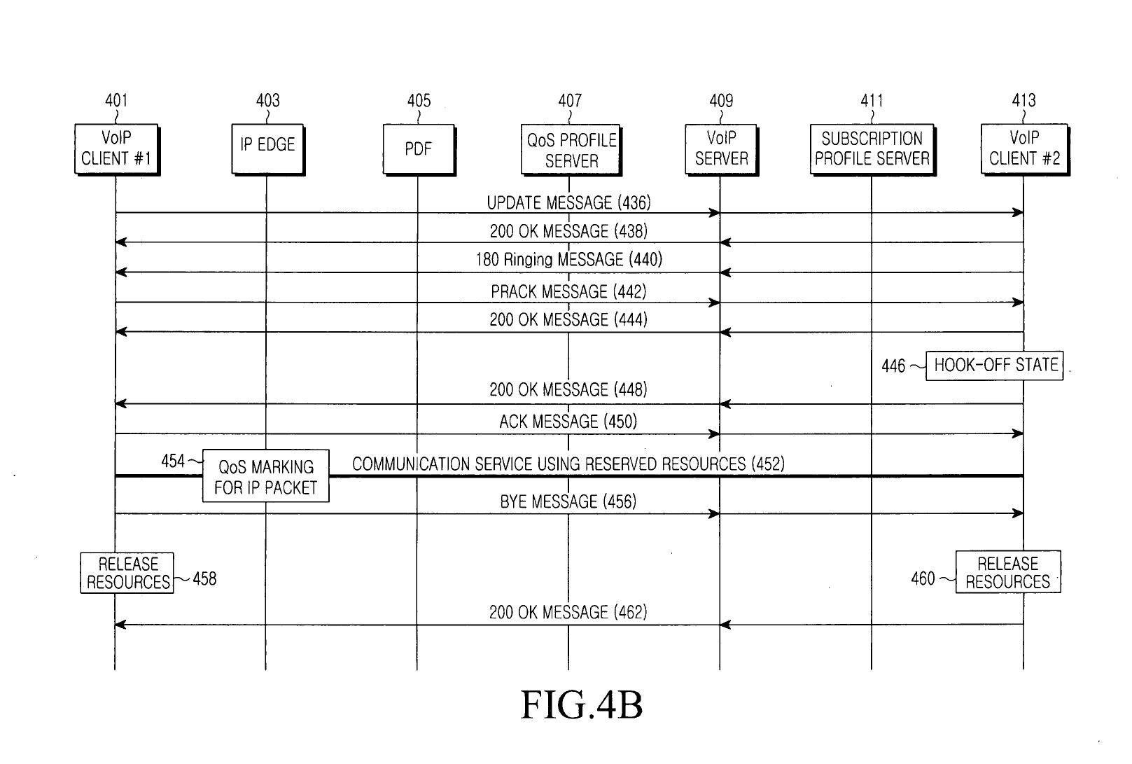

Now, reference will be made to FIGS. 3, 4A and 4B to describe a registration process and a session establishment process according to an embodiment of the present invention, in which a VoIP network includes a PDF.

FIG. 3 shows a procedure for registering a user in a VoIP network according to an embodiment of the present invention.

Referring to FIG. 3, the VoIP network includes a VoIP client #1 301, an IP edge 303, a PDF 305, a QoS profile server 307, a VoIP server 309, a subscription profile server 311, and a VoIP client #2 313.

The VoIP client #1 301, or a transmitting terminal, transmits a REGISTER message for requesting registration to the VoIP server 309 in block 310. The VoIP server 309 requests the subscription profile server 311 to provide user authentication information for the VoIP client #1 301 in block 312, and then acquires the user authentication information from the subscription profile server 311 in block 314.

The VoIP server 309 performs authentication by comparing the acquired user authentication information with pre-stored information about the VoIP client #1 301. If the acquired user authentication information is not coincident with the information about the VoIP client #1 301, the VoIP server 309 transmits a 401 Unauthorized message indicating the authentication failure to the VoIP client #1 301 in block 316.

Upon receiving the 401 Unauthorized message, the VoIP client #1 301 re-transmits the REGISTER message to the VoIP server 309 in block 318. Then the VoIP server 309 performs authentication by comparing the acquired user authentication information with the information about the VoIP client #1 301. If the VoIP server 309 succeeds in user authentication in block 320 as the acquired user authentication information is coincident with the information about the VoIP client #1 301, the VoIP server 309 requests the subscription profile server 311 to provide a user service profile in block 322, and acquires the user service profile including user priority information from the subscription profile server 311 in block 324.

Thereafter, the VoIP server 309 transmits the user priority information acquired from the subscription profile server 311 to the VoIP client #1 301 using a 200 OK message in block 326. The VoIP client #1 301 acquires its user priority information from the 200 OK message in block 328. The 200 OK message means a response message to the REGISTER message sent in block 318.

FIGS. 4A and 4B show a procedure for establishing a session in a VoIP network according to the embodiment of the present invention depicted in FIG. 3.

In FIGS. 4A and 4B, the VoIP network includes a VoIP client #1 401, an IP edge 403, a PDF 405, a QoS profile server 407, a VoIP server 409, a subscription profile server 411, and a VoIP client #2 413. In FIGS. 4A and 4B, for convenience, the description will be made based on an operation of the VoIP client #1 401, or a transmitting terminal. Accordingly, the IP edge 403, the PDF 405, the QoS profile server 407, the VoIP server 409 and the subscription profile server 411 represent components included in the transmitting VoIP network. The operation of the VoIP client #1 401 is performed in the same way even in the VoIP client #2 413, or a receiving terminal.

Referring to FIG. 4A, the VoIP client #1 401 transmits an INVITE message to the VoIP client #2 413, or a receiving terminal, through the VoIP server 409 in block 410, the INVITE message including the VoIP client #1's SDP information, for example, information about the codec and bandwidth now in use, and the VoIP client #1's priority information acquired from the subscription profile server 411. Herein, the SDP information of the VoIP client #1 401 is represented by SDP#1, and the priority information of the VoIP client #1 401 is assumed to be the highest priority, or Priority-1.

In block 412, the VoIP client #2 413 transmits a 183 Session Progress message including its SDP information and priority information to the VoIP client #1 401 through the VoIP server 409. The 183 Session Progress message means a response message to the INVITE message. Herein, the SDP information of the VoIP client #2 413 is represented by SDP#2, and the priority information of the VoIP client #2 413 is assumed to be Priority-2.

Based on the SDP#1 and SDP #2, the VoIP client #1 401 decides the final SDP information it will use for communication. In block 414, the VoIP client #1 401 transmits the decided final SDP information to the VoIP client #2 413 via the VoIP server 409 using a Provisional Response Acknowledgement (PRACK) message. In block 416, the VoIP client #2 413 transmits a 200 OK message to the VoIP client #1 401 via the VoIP server 409 in response to the PRACK message.

In block 418, the VoIP server 409 transmits a Diameter message to the PDF 405, the Diameter message including the SDP#1 and SDP#2, and priority information having a higher priority value among the priority information of the VoIP client #1 401 and the priority information of the VoIP client #2 413. The VoIP server 409 and the PDF 405 are separately included in each of the transmitting VoIP network 105 and the receiving VoIP network 119 as shown in FIG. 1. Therefore, a transmitting VoIP server transmits the Diameter message to a transmitting PDF, and a receiving VoIP server transmits the Diameter message to a receiving PDF.

In block 420, the PDF 405 transmits a request for a QoS profile of the VoIP client #1 401 and the VoIP client #2 413 to the QoS profile server 407 using a Diameter message. In block 422, the PDF 405 acquires the QoS profile from the QoS profile server 407. In block 424, based on the QoS profile acquired from the QoS profile server 407, the PDF 405 authenticates whether it can provide the service to each of the VoIP client #1 401 and the VoIP client #2 413 in response to a QoS request included in the SDP#1 and SDP#2. In block 426, the PDF 405 transmits the authentication results to the VoIP server 409 using a Diameter message. The VoIP server 409 may continue or stop the current ongoing session establishment procedure depending on the authentication results.

In block 428, the PDF 405 generates a QoS decision value based on the authentication results, and the QoS decision value includes a QCI, an MBR/GBR and a QoS marking value. The PDF 405 updates the generated QoS decision value if a priority value included in the Diameter message received in block 418 is higher than a priority value of the user. That is, while the generated QoS decision value is maintained in the transmitting VoIP network, the generated QoS decision value is upgraded in the receiving VoIP network since a priority value of the VoIP client #1 401 is higher than a priority value of the VoIP client #2 413.

An operation of upgrading the generated QoS decision value by the PDF 405 will be described as follows.

In some embodiments, a QoS decision value has been set as follows, which is decided with the establishment of a session through which a transmitting terminal A with Priority-3 and a receiving terminal B with Priority-1 will perform a voice call.
QCI: A
GBR: 64 Kbps
QoS marking: Assured Forwarding (AF)

However, because the terminal B is higher in priority value than the terminal A, the decided QoS decision value is upgraded as follows.
QCI: A
GBR: 64 Kbps
QoS marking: Expedited Forwarding (EF)

That is, the QoS marking value is upgraded from ‘AF’, which was automatically set according to the QCI, to ‘EP’, which was set depending on the priority of the terminal B.

In block 430, the PDF 405 transmits the generated final QoS decision value to the IP edge 403. The QoS decision value may be transmitted from the PDF 405 to the IP edge 403 as a response to a request of the IP edge 403.

In block 432, with use of the received QoS decision value, the IP edge 403, together with the VoIP client #1 401, generates a bearer connection meeting characteristics of the QoS class and providing a bandwidth corresponding to the MBR/GBR, and reserves resources corresponding thereto.

Though not shown in FIG. 4A, in block 434, the VoIP client #2 413 also reserves resources through the same process as the resource reservation process of the VoIP client #1 401.

Next, referring to FIG. 4B showing the procedure following block 434 of FIG. 4A, the VoIP client #1 401 transmits an UPDATE message to the VoIP client #2 413 via the VoIP server 409 in block 436. In response to the UPDATE message, the VoIP client #2 413 transmits a 200 OK message to the VoIP client #1 401 through the VoIP server 409 in block 438.

Thereafter, in block 440, the VoIP client #2 413 transmits a 180 Ringing message to the VoIP client #1 401 via the VoIP server 409.

In block 442, the VoIP client #1 401 transmits a PRACK message to the VoIP client #2 413 via the VoIP server 409. In block 444, the VoIP client #2 413 transmits a 200 OK message to the VoIP client #1 401 through the VoIP server 409 in response to the PRACK message. In block 446, the VoIP client #2 413 enters a hook-off state if it accepts a communication service requested through the currently established session. In block 448, the VoIP client #2 413 transmits a 200 OK message indicating the hook-off state to the VoIP client #1 401 via the VoIP server 409. In block 450, the VoIP client #1 401 transmits an ACK message indicating receipt of the 200 OK message to the VoIP client #2 413 via the VoIP server 409.

In block 452, the VoIP client #1 401 and the VoIP client #2 413 perform a communication service using the resources and bearer connection reserved and generated in blocks 432 and 434. In block 454, the IP edge 403 performs QoS marking defined in the QoS decision value, for example, DSCP code marking, on each IP packet transmitted through the bearer connection.

In block 456, the VoIP client #1 401 transmits a BYE message to the VoIP client #2 413 through the VoIP server 409 to end the communication service, that is, to release the currently established session and bearer connection. In blocks 458 and 460, the VoIP client #1 401 and the VoIP client #2 413 each release their currently reserved resources. In block 462, the VoIP client #2 413 transmits a 200 OK message to the VoIP client #1 401 via the VoIP server 409 in response to the BYE message.

So far, description has been made of an operation in which the VoIP server 409 provides the PDF 405 with a higher priority value among the priority values of the receiving terminal and the transmitting terminal, and the PDF 405 upgrades the QoS decision value if the received priority value is higher than the priority value of the user, in FIGS. 4A and 4B. Alternatively, the VoIP server 409 may provide the PDF 405 with a lower priority value among the priority values of the receiving terminal and the transmitting terminal, and the PDF 405 may downgrade the QoS decision value if the received priority value is lower than the priority value of the user.

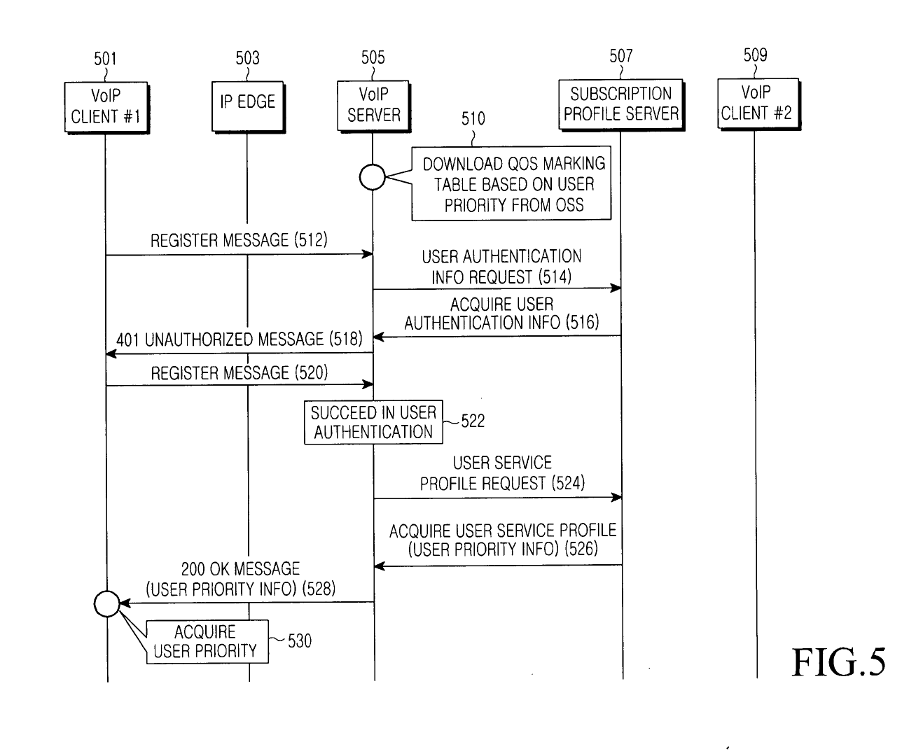

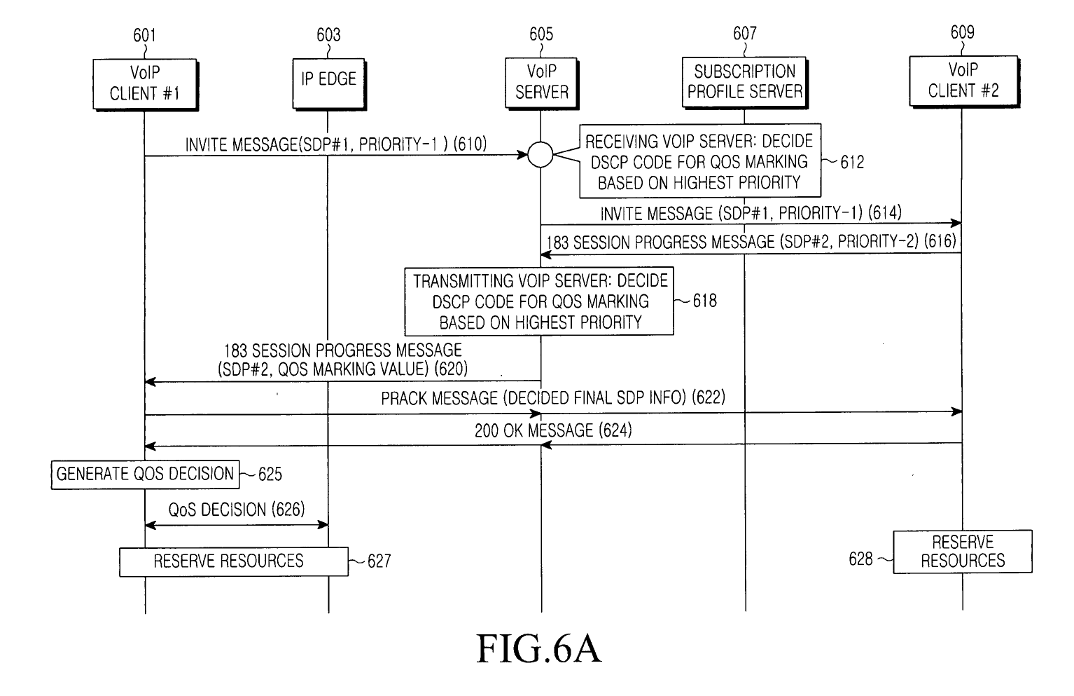

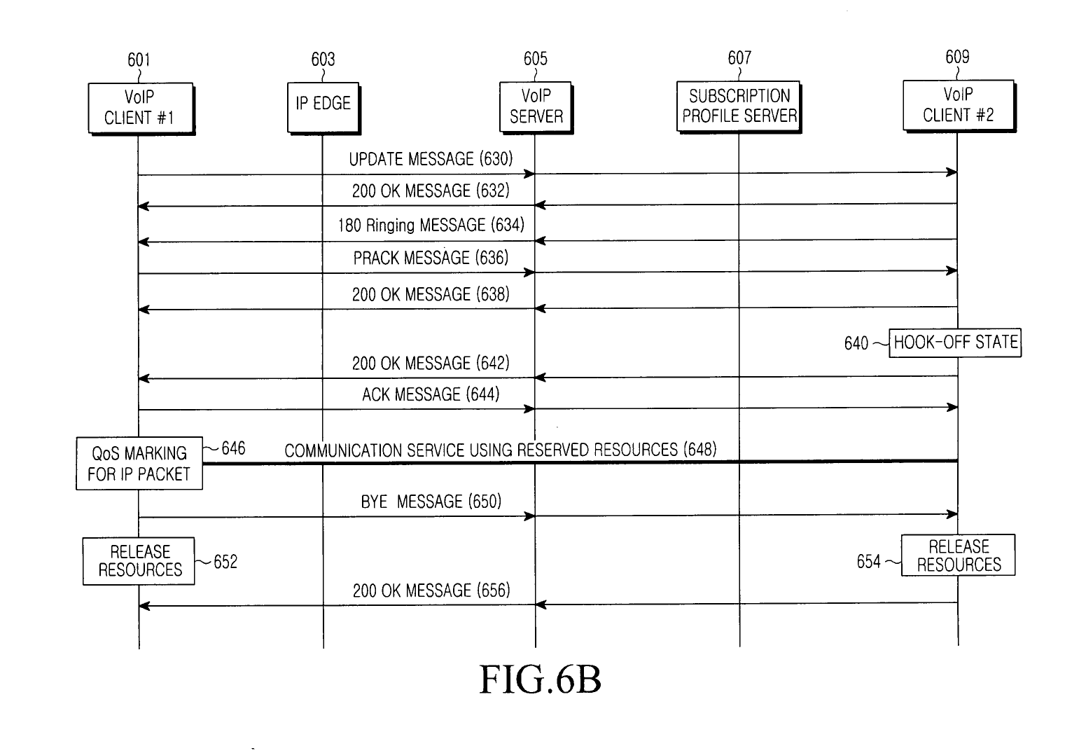

Now, reference will be made to FIGS. 5, 6A and 6B to describe a registration process and a session establishment process according to another embodiment of the present invention, in which a VoIP network includes no PDF and a QoS marking table (a table in which QoS marking information capable of meeting QoS requirements specific to a user priority is written) is not transmitted to the user.

FIG. 5 shows a procedure for registering a user in a VoIP network according to another embodiment of the present invention.

Referring to FIG. 5, the VoIP network includes a VoIP client #1 501, an IP edge 503, a VoIP server 505, a subscription profile server 507, and a VoIP client #2 509.

In block 510, the VoIP server 505 downloads a QoS marking table from an OSS. In block 512, the VoIP client #1 501, for example, a user or a transmitting terminal, transmits a REGISTER message for requesting registration to the VoIP server 505. The VoIP server 505 requests the subscription profile server 507 to provide user authentication information for the VoIP client #1 501 in block 514, and acquires the user authentication information from the subscription profile server 507 in block 516.

The VoIP server 505 performs authentication by comparing the acquired user authentication information with pre-stored user authentication information. If the acquired user authentication information is not coincident with the pre-stored user authentication information, the VoIP server 505 transmits a 401 Unauthorized message indicating the authentication failure to the VoIP client #1 501 in block 518.

Then the VoIP client #1 501 re-transmits the REGISTER message to the VoIP server 505 in block 520, and the VoIP server 505 performs authentication by comparing the acquired user authentication information with the pre-stored user authentication information.

If the VoIP server 505 succeeds in user authentication in block 522 as the acquired user authentication information is coincident with the pre-stored user authentication information, the VoIP server 505 requests the subscription profile server 507 to provide a user service profile in block 524, and acquires the user service profile including user priority information from the subscription profile server 507 in block 526. Thereafter, in block 528, the VoIP server 505 transmits the user priority information acquired from the subscription profile server 507 to the VoIP client #1 501 using a 200 OK message. In block 530, the VoIP client #1 501 acquires the user priority information. The 200 OK message means a response message to the REGISTER message sent in block 520.

FIGS. 6A and 6B show a procedure for establishing a session in a VoIP network according to the embodiment of the present invention depicted in FIG. 5.

In FIGS. 6A and 6B, the VoIP network includes a VoIP client #1 601, an IP edge 603, a VoIP server 605, a subscription profile server 607, and a VoIP client #2 609. In FIGS. 6A and 6B, for convenience, the description will be made based on an operation of the VoIP client #1 601, or a transmitting terminal. Accordingly, the IP edge 603, the VoIP server 605 and the subscription profile server 607 represent components included in the transmitting VoIP network. The operation of the VoIP client #1 601 is performed in the same way even in the VoIP client #2 609, or a receiving terminal.

Referring to FIG. 6A, the VoIP client #1 601 transmits an INVITE message to the VoIP server 605 in block 610, the INVITE message including the VoIP client #1's SDP information SDP#1 and the VoIP client #1's priority information Priority-1 acquired from the subscription profile server 507. Since a receiving VoIP server already knows the priority value of the VoIP client #2 609 or the receiving terminal, the receiving VoIP server compares the priority value of the VoIP client #1 601, received in block 610, with the priority value of the VoIP client #2 609.

Thereafter, the receiving VoIP server decides a DSCP code for QoS marking based on a QoS request included in the SDP information of a client having a higher priority value among the received priority value of the VoIP client #1 601 and the priority value of the VoIP client #2 609. That is, in block 612, the receiving VoIP server decides the DSCP code for QoS marking based on the QoS request included in the SDP information of the VoIP client #1 601 having the highest priority. In deciding the DSCP code, the receiving VoIP server uses the QoS marking table it downloaded in block 510.

In block 614, the VoIP server 605 transmits the INVITE message to the VoIP client #2 609. In response, the VoIP client #2 609 transmits a 183 Session Progress message to the VoIP server 605 in block 616, the 183 Session Progress message including the VoIP client #2's SDP information SDP#2 and the VoIP client #2's priority information Priority-2 acquired from the subscription profile server 507.

At approximately the same time, a transmitting VoIP server compares the priority value of the VoIP client #1 601, received in block 610, with the priority value of the VoIP client #2 609, received in block 616. Thereafter, the transmitting VoIP server decides a DSCP code for QoS marking based on a QoS request included in SDP information of the client having a higher priority value among the two priority values. That is, in block 618, the transmitting VoIP server decides a DSCP code for QoS marking using the QoS marking table downloaded in block 510 based on a QoS request included in the SDP information of the VoIP client #1 610 having the highest priority.

In block 620, the VoIP server 605 transmits a 183 Session Progress message including the SDP#2 and the QoS marking value corresponding to the decided DSCP code, to the VoIP client #1 601.

In block 622, the VoIP client #1 601 decides final SDP information it will use for communication, based on the SDP#1 and SDP#2, and transmits the decided final SDP information to the VoIP client #2 609 via the VoIP server 605 using a PRACK message. In block 624, the VoIP client #2 609 transmits a 200 OK message to the VoIP client #1 601 via the VoIP server 605 in response to the PRACK message.

In block 625, the VoIP client #1 601 generates a QoS decision value based on the decided final SDP information and the QoS marking value received in block 620. The QoS decision value includes a QCI, an MBR/GBR and a QoS marking value. In block 626, the VoIP client #1 601 transmits the generated QoS decision value to the IP edge 603, and the QoS decision value may be transmitted in response to a request of the IP edge 603.

In block 627, the IP edge 603, together with the VoIP client #1 601, generates a bearer connection meeting characteristics of the QoS class and providing a bandwidth corresponding to the MBR/GBR, using the received QoS decision value, and reserves resources corresponding thereto.

Although not shown in FIG. 6A, the VoIP client #2 609 also reserves resources through the same process as the resource reservation process of the VoIP client #1 601 in block 628.

Next, referring to FIG. 6B showing the procedure following block 628 of FIG. 6A, the VoIP client #1 601 transmits an UPDATE message to the VoIP client #2 609 via the VoIP server 605 in block 630. Then, in block 632, the VoIP client #2 609 transmits a 200 OK message to the VoIP client #1 601 via the VoIP server 605 in response to the UPDATE message. Thereafter, in block 634, the VoIP client #2 609 transmits a 180 Ringing message to the VoIP client #1 601 via the VoIP server 605.

In block 636, the VoIP client #1 601 transmits a PRACK message to the VoIP client #2 609 via the VoIP server 605. In block 638, the VoIP client #2 609 transmits a 200 OK message to the VoIP client #1 601 via the VoIP server 605 in response to the PRACK message. In block 640, the VoIP client #2 609 enters a hook-off state if it accepts a communication service requested through the currently established session. In block 642, the VoIP client #2 609 transmits a 200 OK message indicating the hook-off state to the VoIP client #1 601 via the VoIP server 605. In block 644, the VoIP client #1 601 transmits an ACK message indicating receipt of the 200 OK message to the VoIP client #2 609 via the VoIP server 605.

In block 648, the VoIP client #1 601 and the VoIP client #2 609 perform a communication service using the resources reserved in blocks 627 and 628. In block 646, the VoIP client #1 601 performs QoS marking defined in the QoS decision value, for example, DSCP code marking, on the IP packet transmitted through the bearer connection.

In block 650, the VoIP client #1 601 transmits a BYE message to the VoIP client #2 609 via the VoIP server 605 to end the communication service, that is, to release the currently established session and bearer connection. In blocks 652 and 654, the VoIP client #1 601 and the VoIP client #2 609 each release their currently reserved resources. In block 656, the VoIP client #2 609 transmits a 200 OK message to the VoIP client #1 601 via the VoIP server 605 in response to the BYE message.

So far, the description has been made of an operation in which the VoIP server 605 decides a DSCP code for QoS marking based on a terminal having a higher priority value among the priority values of the receiving terminal and the transmitting terminal in FIGS. 6A and 6B. However, the VoIP server 605 may decide a DSCP code for QoS marking based on a terminal having a lower priority value among the receiving terminal and the transmitting terminal.

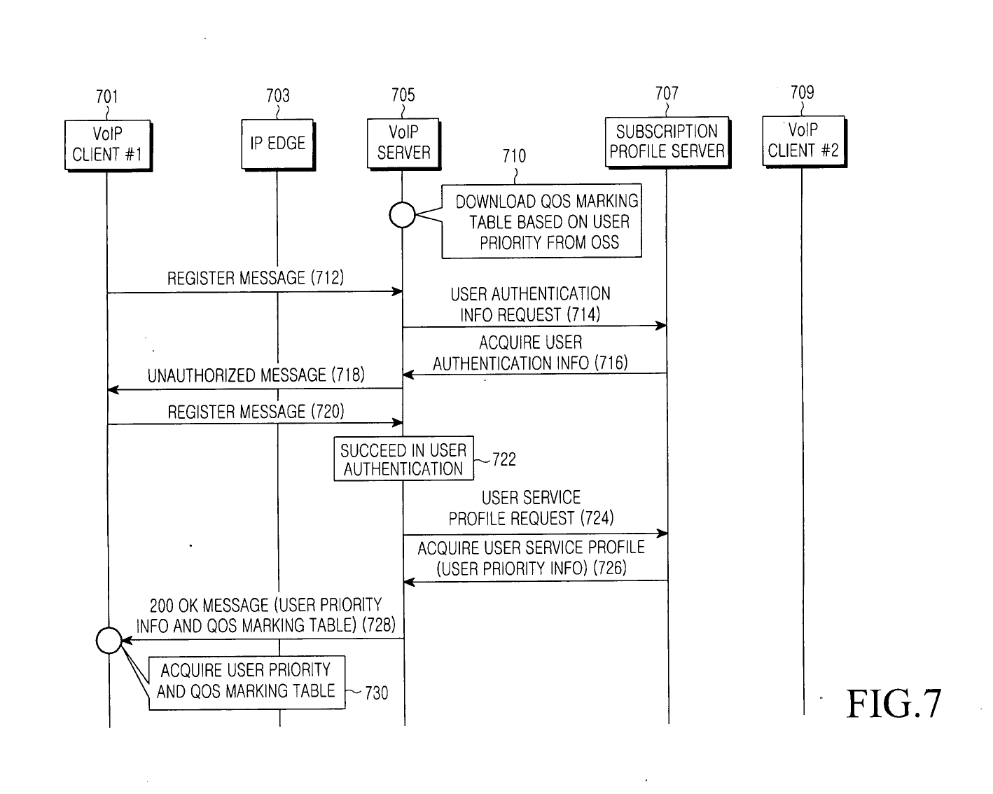

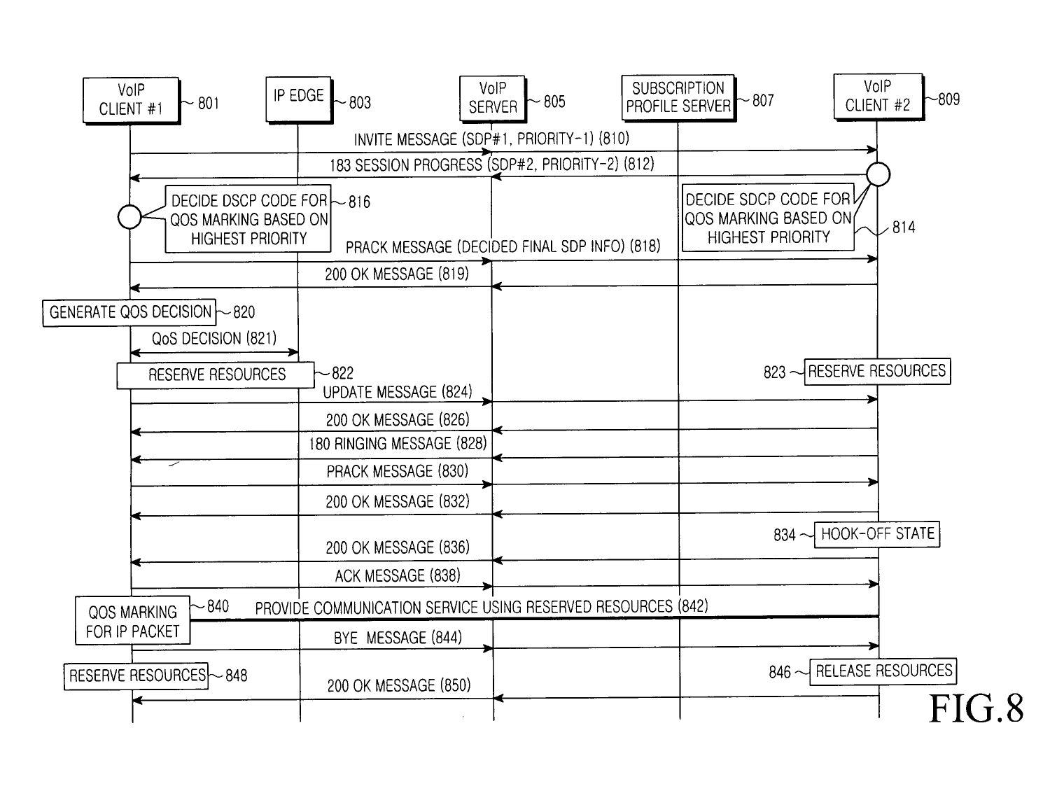

Now, reference will be made to FIGS. 7 and 8 to describe a registration process and a session establishment process according to another embodiment of the present invention, in which a VoIP network has no PDF and transmits a QoS marking table to users.

FIG. 7 shows a procedure for registering a user in a VoIP network according to another embodiment of the present invention.

Referring to FIG. 7, the VoIP network includes a VoIP client #1 701, an IP edge 703, a VoIP server 705, a subscription profile server 707, and a VoIP client #2 709.

In block 710, the VoIP server 705 downloads a QoS marking table from an OSS. In block 712, the VoIP client #1 701, for example, a user or a transmitting terminal, transmits a REGISTER message for requesting registration to the VoIP server 705. Then the VoIP server 705 requests the subscription profile server 707 to provide user authentication information for the VoIP client #1 701 in block 714, and acquires the user authentication information from the subscription profile server 707 in block 716. The VoIP server 705 performs authentication by comparing the acquired user authentication information with the pre-stored information about the VoIP client #1 701. If the acquired user authentication information is not coincident with the pre-stored information about the VoIP client #1 701, the VoIP server 705 transmits a 401 Unauthorized message indicating the authentication failure to the VoIP client #1 701 in block 718.

In block 720, upon receipt of the 401 Unauthorized message, the VoIP client #1 701 re-transmits the REGISTER message to the VoIP server 705. Then, the VoIP server 705 performs authentication by comparing the acquired user authentication information with the pre-stored information about the VoIP client #1 701.

If the VoIP server 705 succeeds in user authentication in block 722 as the acquired user authentication information is coincident with the pre-stored information about the VoIP client #1 701, the VoIP server 705 requests the subscription profile server 707 to provide a user service profile in block 724, and acquires the user service profile including user priority information from the subscription profile server 707 in block 726.

Thereafter, the VoIP server 705 transmits a 200 OK message to the VoIP client #1 701 in block 728, the 200 OK message including the user priority information acquired from the subscription profile server 707 and the QoS marking table downloaded in block 710. In block 730, the VoIP client #1 701 acquires the user priority information and QoS marking table. The 200 OK message means a response message to the REGISTER message sent in block 720.

FIG. 8 shows a procedure for establishing a session in a VoIP network according to the embodiment of the present invention depicted in FIG. 7.

Referring to FIG. 8, the VoIP network includes a VoIP client #1 801, an IP edge 803, a VoIP server 805, a subscription profile server 807, and a VoIP client #2 909. In FIG. 8, for convenience, the description will be made based on an operation of the VoIP client #1 801, or a transmitting terminal. Accordingly, the IP edge 803, the VoIP server 805 and the subscription profile server 807 represent components included in the transmitting VoIP network. The operation of the VoIP client #1 801 is performed in the same way even in the VoIP client #2 809, or a receiving terminal.

In block 810, the VoIP client #1 801 transmits an INVITE message to the VoIP client #2 809 or a receiving terminal via the VoIP server 805, the INVITE message including the VoIP client #1's SDP information SDP#1 and the VoIP client #1's priority information Priority-1 acquired from the subscription profile server 807.

In block 812, the VoIP client #2 809 transmits a 183 Session Progress message to the VoIP client #1 801 via the VoIP server 805, the 183 Session Progress message including the VoIP client #2's SDP information SDP#2 and the VoIP client #2's priority information Priority-2 acquired from the subscription profile server 707. In block 814, the VoIP client #2 809 compares the priority value of the VoIP client #1 801, received in block 810, with its own priority value, and decides a DSCP code for QoS marking based on the VoIP client #1 801 having the highest priority value among the priority value of the VoIP client #1 801 and the priority value of the VoIP client #2 809. To decide the DSCP code, the VoIP client #2 809 uses the QoS marking table received from a receiving VoIP server.

In block 816, the VoIP client #1 801 compares the priority value of the VoIP client #2 809, received in block 812, with its own priority value, and decides a DSCP code for QoS marking based on the VoIP client #1 801 having the highest priority value among the priority value of the VoIP client #2 809 and the priority value of the VoIP client #1 801. To decide the DSCP code, the VoIP client #1 801 uses the QoS marking table received in block 728.

In block 818, the VoIP client #1 801 decides the final SDP information it will use for communication, based on the SDP#1 and SDP#2, and transmits the decided final DSP information to the VoIP client #2 809 through the VoIP server 805 using a PRACK message. In block 819, the VoIP client #2 809 transmits a 200 OK message to the VoIP client #1 801 via the VoIP server 805 in response to the PRACK message.

In block 820, the VoIP client #1 801 generates a QoS decision value based on the decided final DSP information and the QoS marking value corresponding to the DSCP code decided in block 816. The QoS decision value includes a QCI, an MBR/GBR and a QoS marking value. In block 821, the VoIP client #1 801 transmits the generated QoS decision value to the IP edge 803. The QoS decision value may be transmitted in response to a request of the IP edge 803.

In block 822, using the received QoS decision value, the IP edge 803, together with the VoIP client #1 801, generates a bearer connection meeting characteristics of the QoS class and providing a bandwidth corresponding to the MBR/GBR, and reserves resources corresponding thereto.

Though not shown in FIG. 8, the VoIP client #2 809 also reserves resources through the same process as the resource reservation process of the VoIP client #1 801 in block 823.

In block 824, the VoIP client #1 801 transmits an UPDATE message to the VoIP client #2 809 via the VoIP server 805. In block 826, the VoIP client #2 809 transmits a 200 OK message to the VoIP client #1 801 via the VoIP server 805 in response to the UPDATE message. Thereafter, in block 828, the VoIP client #2 809 transmits a 180 Ringing message to the VoIP client #1 801 via the VoIP server 805.

In block 830, the VoIP client #1 801 transmits a PRACK message to the VoIP client #2 809 via the VoIP server 805. In block 832, the VoIP client #2 809 transmits a 200 OK message to the VoIP client #1 801 via the VoIP server 805 in response to the PRACK message. In block 834, the VoIP client #2 809 enters a hook-off state if it accepts a communication service requested through the currently established session. In block 836, the VoIP client #2 809 transmits a 200 OK message indicating the hook-off state to the VoIP client #1 801 via the VoIP server 805. In block 838, the VoIP client #1 801 transmits an ACK message for acknowledging receipt of the 200 OK message to the VoIP client #2 809 via the VoIP server 805.

In block 842, the VoIP client #1 801 and the VoIP client #2 809 perform a communication service using the resources reserved in blocks 822 and 823. In block 840, the VoIP client #1 801 performs QoS marking defined in the QoS decision value, for example, DSCP code marking, on the IP packet transmitted through the bearer connection.

In block 844, the VoIP client #1 801 transmits a BYE message to the VoIP client #2 809 via the VoIP server 805 to close the communication service, that is, to release the currently established session and bearer connection. In blocks 848 and 846, the VoIP client #1 801 and the VoIP client #2 809 each release their currently reserved resources. In block 850, the VoIP client #2 809 transmits a 200 OK message to the VoIP client #1 801 via the VoIP server 805 in response to the BYE message.

So far, description has been made of an operation in which the VoIP client #1 801 and the VoIP client #2 809 each decide a DSCP code for QoS marking based on the terminal having a higher priority value among the receiving terminal and the transmitting terminal in FIG. 8. However, the VoIP client #1 801 and the VoIP client #2 809 each may decide a DSCP code for QoS marking based on a terminal having a lower priority value among the receiving terminal and the transmitting terminal.

The user priority information is included in an SIP message such as an INVITE message and/or a 183 Session Progress message, and a new SIP parameter may be defined.

Table 1 shows an example of an INVITE message including user priority information acquired in the user registration procedure.

TABLE 1

INVITE tel: +82-31-279-2222 SIP/2.0
From: <sip:userl_publicl@home1.net>:tag=171828
To: <tel:+82-31-279-2222>
Call-ID: cb03a0s09a2sdfglkj490333
Cseq: 127 INVITE
Contact: <sip:[5555::aaa:bbb:ccc:ddd]:1357>
Max-Forwards: 70
P-Asserted-Service: urn:urn-xxx:3gpp-service.ims.icsi.mmtel
Sub-Priority: 1
Content-Type: application/sdp
Content-Length: (...)

In this way, the user priority information may be represented by defining a new header ‘Sub-Priority’ in the SIP message. Since the lower set value represents the higher priority, the ‘Sub-Priority: 1’ represents the highest priority.

In addition, a user priority-based QoS marking table may be represented as shown in Table 2 by way of example. Table 2 below shows QoS marking based on the user priorities of each service.

TABLE 2

Priority

| Service | 1 | 2 | 3 | 4 | 5 | |
|---|---|---|---|---|---|---|
| SIP Signal | EF | EF | EF | EF | EF | DSCP |
| VoIP | EF | AF1 | AF1 | AF1 | AF1 | Code |
| | EF | AF1 | AF1 | AF1 | AF1 | |
| Voice Value-Added | EF | AF1 | AF1 | AF1 | AF1 | |
| Service | | | | | | |
| Conference | EF | AF1 | AF1 | AF1 | AF1 | |
| Video Conference | EF | AF1 | AF1 | AF1 | AF1 | |
| PTT | EF | AF1 | AF1 | AF1 | AF1 | |
| Presence | EF | EF | EF | EF | EF | |
| SMS | EF | EF | EF | EF | EF | |
| | EF | AF3 | AF3 | AF3 | AF3 | |
| Voice Mail | EF | AF1 | AF1 | AF1 | AF1 | |

As is apparent from the foregoing description, the present invention generates a QoS decision value capable of providing QoS of each terminal, according to priorities of terminals, reserves resources based on the QoS decision value, and performs QoS marking in a communication system, thereby allowing each terminal to be provided differentiated QoS according to its priority.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for providing Quality of Service (QoS) considering a priority of a terminal in a communication system, comprising:
receiving, by a communication server, Session Description Protocol (SDP) information and priority information of each of first and second terminals, and transmitting, to a Policy Decision Function block (PDF), the SDP information of each of the first and second terminals and priority information corresponding to a highest priority in the priority information of the first and second terminals;
performing, by the PDF, authentication for the first and second terminals based on QoS profile information of the first and second terminals acquired from a service profile server upon request for SDP information of each of the first and second terminals, generating a QoS decision value based on the authentication results, and reserving resources that the first terminal will use to perform a communication service with the second terminal, using the QoS decision value; and
upgrading the QoS decision value based on the highest-priority information.

2. The method of claim 1, wherein the QoS decision value comprises a QoS class, a Maximum Bit Rate (MBR)/Guaranteed Bit Rate (GBR), and a QoS marking value.

3. The method of claim 1, wherein the communication server receives the priority information of the first and second terminals from the first and second terminals in a process of registering the first and second terminals.

4. The method of claim 1, wherein when the first terminal performs a communication service with the second terminal using the reserved resources, an Internet Protocol (IP) edge that the first terminal accessed performs QoS marking corresponding to the QoS decision value on each IP packet.

5. A method for providing Quality of Service (QoS) considering a priority of a terminal in a communication system, comprising:
receiving, by a communication server, Session Description Protocol (SDP) information and priority information of each of first and second terminals, identifying priority information corresponding to a highest priority in the priority information of the first and second terminals, deciding a QoS marking value of a terminal having the identified priority information among the first and second terminals using a QoS marking table based on terminal's priority information, and transmitting the decided QoS marking value to the first terminal; and
deciding, by the first terminal, final SDP information that the first terminal will use for communication based on the SDP information of the first and second terminals, generating a QoS decision value using the decided final SDP information and the QoS marking value, and reserving resources that the first terminal will use to perform a communication service with the second terminal using the QoS decision value.

6. The method of claim 5, wherein the QoS decision value comprises a QoS class, a Maximum Bit Rate (MBR)/Guaranteed Bit Rate (GBR), and a QoS marking value.

7. The method of claim 5, wherein the communication server receives the priority information of the first and second terminals from the first and second terminals in a process of registering the first and second terminals.

8. The method of claim 5, wherein the first terminal performs QoS marking on each Internet Protocol (IP) packet according to the QoS decision value while performing a communication service with the second terminal using the reserved resources.

9. The method of claim 5, wherein the communication server receives the QoS marking table from an Operation Supporting System (OSS) in a process of registering the first and second terminals.

10. A method for providing Quality of Service (QoS) considering a priority of a terminal in a communication system, comprising:
receiving, by a first terminal, Session Description Protocol (SDP) information and priority information of a second terminal, identifying priority information corresponding to a highest priority in the priority information of the first and second terminals, and deciding a QoS marking value of a terminal having the identified priority information among the first and second terminals using a QoS marking table based on terminal's priority information; and
deciding final SDP information that the first terminal will use for communication based on the SDP information of the first and second terminals, generating a QoS decision value using the decided final SDP information and the QoS marking value, and reserving resources that the first terminal will use to perform a communication service with the second terminal, using the QoS decision value.

11. The method of claim 10, wherein the QoS decision value comprises a QoS class, a Maximum Bit Rate (MBR)/Guaranteed Bit Rate (GBR), and a QoS marking value.

12. The method of claim 10, wherein in a process of registering a user, the first terminal receives the priority information of the second terminal and the QoS marking table from a communication server providing the communication service.

13. The method of claim 10, further comprising performing by the first terminal a communication service with the second terminal using the reserved resources, and performing QoS marking according to the QoS decision value.

14. The method of claim 12, wherein the communication server receives the QoS marking table from an Operation Supporting System (OSS) in a process of registering the first and second terminals.

15. A system for providing Quality of Service (QoS) considering a priority of a terminal in a communication system, comprising:
a first terminal;
a second terminal;
a communication server configured to receive Session Description Protocol (SDP) information and priority information of each of the first and second terminals, and transmit, to a Policy Decision Function block (PDF), the SDP information of each of the first and second terminals and priority information corresponding to a highest priority in the priority information of the first and second terminals;
a QoS profile server configured to provide QoS profile information of the first and second terminals; and
the PDF for performing authentication for the first and second terminals based on the QoS profile information of the first and second terminals acquired from the QoS profile server upon request for SDP information of each of the first and second terminals, generating a QoS decision value using the authentication results, and reserving resources that the first terminal will use to perform a communication service with the second terminal, using the QoS decision value;
wherein the PDF upgrades the QoS decision value based on the highest-priority information.

16. The system of claim 15, wherein the QoS decision value comprises a QoS class, a Maximum Bit Rate (MBR)/Guaranteed Bit Rate (GBR), and a QoS marking value.

17. The system of claim 15, wherein the communication server receives the priority information of the first and second terminals from the first and second terminals in a process of registering the first and second terminals.

18. The system of claim 15, further comprising an Internet Protocol (IP) edge connected to the first terminal and performing QoS marking corresponding to the QoS decision value on each IP packet, when the first terminal performs a communication service with the second terminal using the reserved resources.

19. A system for providing Quality of Service (QoS) considering a priority of a terminal in a communication system, comprising:
a first terminal;
a second terminal; and
a communication server configured to receive Session Description Protocol (SDP) information and priority information of each of the first and second terminals, identify priority information corresponding to a highest priority in the priority information of the first and second terminals, decide a QoS marking value of a terminal having the identified priority information among the first and second terminals using a QoS marking table based on terminal's priority information, and transmit the decided QoS marking value to the first terminal;
wherein the first terminal decides final SDP information that the first terminal will use for communication based on the SDP information of the first and second terminals, generates a QoS decision value using the decided final SDP information and the QoS marking value, and reserves resources that the first terminal will use to perform a communication service with the second terminal using the QoS decision value.

20. The system of claim 19, wherein the QoS decision value comprises a QoS class, a Maximum Bit Rate (MBR)/Guaranteed Bit Rate (GBR), and a QoS marking value.

21. The system of claim 19, wherein the communication server receives the priority information of the first and second terminals from the first and second terminals in a process of registering the first and second terminals.

22. The system of claim 19, wherein the first terminal performs QoS marking on each Internet Protocol (IP) packet according to the QoS decision value while performing a communication service with the second terminal using the reserved resources.

23. The system of claim 19, wherein the communication server receives the QoS marking table from an Operation Supporting System (OSS) in a process of registering the first and second terminals.

24. A system for providing Quality of Service (QoS) considering a priority of a terminal in a communication system, comprising:
a first terminal;
a second terminal; and
a communication server configured to provide a communication service of the second terminal to the first terminal;
wherein the first terminal receives Session Description Protocol (SDP) information and priority information of the second terminal, identifies priority information corresponding to a highest priority in the priority information of the first and second terminals, decides a QoS marking value of a terminal having the identified priority information among the first and second terminals using a QoS marking table based on terminal's priority information, decides final SDP information that the first terminal will use for communication based on the SDP information of the first and second terminals, generates a QoS decision value using the decided final SDP information and the QoS marking value, and reserves resources that the first terminal will use to perform a communication service with the second terminal, using the QoS decision value.

25. The system of claim 24, wherein the QoS decision value comprises a QoS class, a Maximum Bit Rate (MBR)/Guaranteed Bit Rate (GBR), and a QoS marking value.

26. The system of claim 24, wherein the first terminal receives the priority information of the second terminal and the QoS marking table from the communication server in a user registration process.

27. The system of claim 24, wherein the first terminal performs a communication service with the second terminal using the reserved resources, and performs QoS marking according to the QoS decision value.

28. The system of claim 24, wherein the communication server receives the QoS marking table from an Operation Supporting System (OSS) in a process of registering the first and second terminals.
